(19) United States
(12) Patent Application Publication
(10) Pub. No.: US 2017/0206711 A1
(43) Pub. Date: Jul. 20, 2017

(54) VIDEO-ENHANCED GREETING CARDS

(71) Applicant: Mage Inc., Santa Clara, CA (US)

(72) Inventors: An Li, Santa Clara, CA (US); Libo Su, San Jose, CA (US); Xing Zhang, Mountain View, CA (US)

(21) Appl. No.: 15/395,306

(22) Filed: Dec. 30, 2016

Related U.S. Application Data
(60) Provisional application No. 62/273,137, filed on Dec. 30, 2015.

(51) Int. Cl. G06T 19/00; G06F 3/0484; G06K 9/00; G06T 15/00

(52) U.S. Cl. CPC G06T 19/006; G06T 15/005; G06F 3/04842; G06K 9/00711

(57) ABSTRACT

Provided are computer systems, methods, and non-transitory computer-readable medium configured for receiving or generating a video, extracting a still image from the video, printing the still image on a physical card and sharing the card. Viewing of the card can be augmented by the system that captures an image of the printed image on the card, uses the image to identify the video from which the printed image is extracted, and overlays the video on a visual representation of the card on the system, thereby generating an animated viewing experience from a card having a still image. Three-dimensional contents can be added to the augmented reality presentation, further enhancing the user experience.

### CROSS REFERENCE TO RELATED APPLICATIONS

This application claims the benefit under 35 U.S.C. §119(e) of U.S. Provisional Application No. 62/273,137, filed Dec. 30, 2015, the content of which is incorporated by reference in its entirety.

### BACKGROUND

Postcards and paper-based greeting cards have gradually been replaced by electronic cards (e-card) or greeting messages transmitted across computing devices. An e-card is created using digital media and is sometimes available by publishers usually on various Internet sites, where it can be sent to a recipient, usually via e-mail. It also considered more environmentally friendly compared to traditional paper cards. Electronic greeting can also be created as an electronic message (e.g., email) or social networking posts.

E-cards are digital “content”, which makes them much more versatile than traditional greeting cards. For example, unlike traditional greetings, E-cards can be easily sent to many people at once or extensively personalized by the sender.

Nevertheless, paper-based greeting cards have certain properties making it impossible to be entirely replaced by electronic means. For instance, paper cards can be displayed without being attached to a power supply and can be smelled if scented. Further, compared to electronic cards, paper cards can fade in color, which can carry a sense of aging.

### SUMMARY

The present disclosure describes, in one embodiment, a system for information sharing. In one aspect, the system comprises a processor, memory, an optical sensor, a display unit and program code comprising an image selection module, a sharing module, an archiving module, a receiving module and recognition module and an augmenting module. In some embodiments, the system further comprises a 3D rendering module.

The image selection module, in some aspects, configures the system to receive a first video from a storage medium or capture a first video, display at least part of the first video with the display unit, receive a user input, and extract a first still image from the first video based on the user input.

The sharing module, in some aspects, configures the system to transmit the first still image to a remote device for printing or displaying.

The archiving module, in some aspects, configures the system to transmit the first video to a remote repository;

The receiving module, in some aspects, configures the system to generate a visual representation of at least part of a second still image with the optical sensor for later module processing and display the visual representation with the display unit;

The recognition module, in some aspects, configures the system to identify a second video from which the second still image is extracted, from the remote repository and taking the visual representation as input; and

The augmenting module, in some aspects, configures the system to determine the location of the second still image and display the second video with the display unit and overlay the second video on the visual representation at the location. In some embodiments, also displayed are three-dimensional contents which can be customized by a user. Determination of the location can be made by identifying a two-dimensional transformation between the second still image and a frame of the second video, and calculating the location of the second video based on the two-dimensional transformation and characteristics of the optic sensor.

In some aspects, the image selection module configures the system to capture the first video. In some aspects, the sharing module configures the remote device to print the first still image. In some aspects, the archiving module further configures the system to transmit the first still image to the remote repository. In some aspects, the archiving module further configures the system to identify the first still image as associated with the first video.

In some aspects, the second video is identified by matching the second still image to one or more frames of the second video. In some aspects, the second video is identified by matching the second still image to a still image identified by the remote repository as associated with the second video.

In some aspects, when the second video is overlaid on the visual representation, the visual representation is removed from the display on the display unit. In some aspects, when the second video is overlaid on the visual representation, the visual representation is blended into the second video.

Three-dimensional contents can be optionally displayed along with the video, in some embodiments. Accordingly, in some aspects, the system further includes a 3D rendering module that configures the system to allow a user to add a three-dimensional content to be played along with a video. In some aspects, the three-dimensional content comprises text. In some aspects, the three-dimensional content comprises fireworks. In some aspects, the fireworks are configured so that when the fireworks fall after peaking, the speed of the falling is reduced to allow viewing of the fireworks. The reduction can be achieved by, for example, reducing or eliminating gravity.

Also provided, in one embodiment, is a system for information sharing, comprising a processor, memory, an optical sensor, a display unit and program code comprising: an image selection module that configures the system to receive a first video from a storage medium or capture a first video, display at least part of the first video with the display unit, receive a user input, and extract a first still image from the first video based on the user input; a sharing module that configures the system to transmit the first still image to a remote device for printing or displaying; an archiving module that configures the system to transmit the first video to a remote repository; a receiving module that configures the system to generate a visual representation of at least part of a second still image with the optical sensor; a recognition module that configures the system to identify a second video from which the second still image is extracted, from the remote repository and taking the visual representation as input; and an augmenting module that configures the system to: (i) determine the location of the second still image by (a) identifying a two-dimensional transformation between the second still image and a frame of the second video, and (b) calculating the location of the second video based on the two-dimensional transformation and characteristics of the optic sensor; and (ii) display the second video with the display unit and overlay the second video on the visual representation at the location.

Further provided in one embodiment is a non-transitory computer-readable medium that embeds program code comprising: an image selection module that configures a system that comprises a processor, memory, an optical sensor, and a display unit to receive a first video from a storage medium or capture a first video, display at least part of the first video with the display unit, receive a user input, and extract a first still image from the first video based on the user input; a sharing module that configures the system to transmit the first still image to a remote device for printing or displaying; an archiving module that configures the system to transmit the first video to a remote repository; a receiving module that configures the system to generate a visual representation of at least part of a second still image with the optical sensor; a recognition module that configures the system to identify a second video from which the second still image is extracted, from the remote repository and taking the visual representation as input; and an augmenting module that configures the system to: (i) determine the location of the second still image by (a) identifying a two-dimensional transformation between the second still image and a frame of the second video, and (b) calculating the location of the second video based on the two-dimensional transformation and characteristics of the optic sensor; and (ii) display the second video with the display unit and overlay the second video on the visual representation at the location.

### BRIEF DESCRIPTION OF THE DRAWINGS

FIG. 1A-1D illustrate the process of one embodiment of the disclosure for generating and sharing a video-enhanced greeting card; and

FIG. 2 shows an example of a computer system on which techniques described in this paper can be implemented.

It will be recognized that some or all of the figures are schematic representations for example and, hence, that they do not necessarily depict the actual relative sizes or locations of the elements shown.

### DETAILED DESCRIPTION

In one embodiment, the present disclosure provides a system for information sharing, which system includes a processor, memory, an optical sensor, a display unit and suitable program code. The program code, in some aspects, includes a number of modules which, when executed, configures the system to carry out a number of functions.

One portion of the program code, referred to as an image selection module, can configure the system to receive a first video from a storage medium or capture a first video, display at least part of the first video with the display unit, receive a user input, and extract a first still image from the first video based on the user input.

Another portion of the program code, referred to as a sharing module, can configure the system to transmit the first still image to a remote device for printing or displaying.

Another portion of the program code, referred to as a preview module (or a 3D rendering module if any 3D content is involved). The 3D rendering module allows a user to add a three-dimensional content to be played along with a video.

Another portion of the program code, referred to as an archiving module, can configure the system to transmit the first video to a remote repository.

Another portion of the program code, referred to as a receiving module, can configure the system to generate a visual representation of at least part of a second still image with the optical sensor and display the visual representation with the display unit.

Another portion of the program code, referred to as a recognition module, can configure the system to identify a second video from which the second still image is extracted, from the remote repository and taking the visual representation as input.

Yet another portion of the program code, referred to as an augmenting module, can configure the system to display the second video with the display unit and overlay the second video on the visual representation. In some embodiments, 3D content associated with the video can also be played.

### Image Selection from a Video

In one embodiment, the program code of the system includes computer-readable instructions to carry out an image selection function which can be referred to as an image selection module.

The image, in one aspect, is selected from a video or animated file, which can be captured by an optical sensor (e.g., as part of a camera) of the system, generated or compiled from videos or images from a storage medium inside or outside the system, or retrieved from a storage medium inside or outside the system.

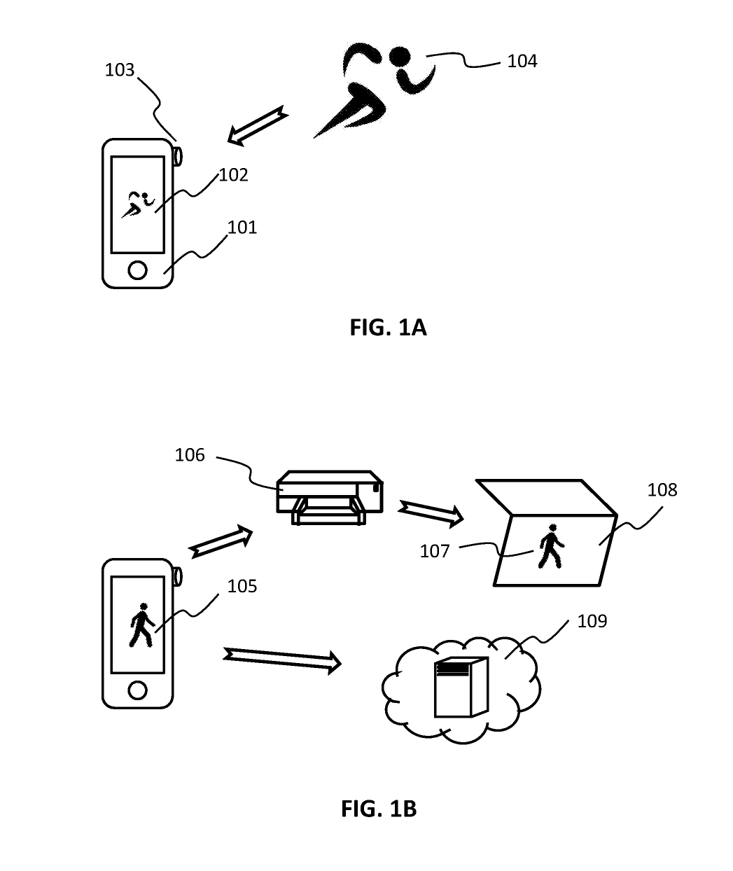

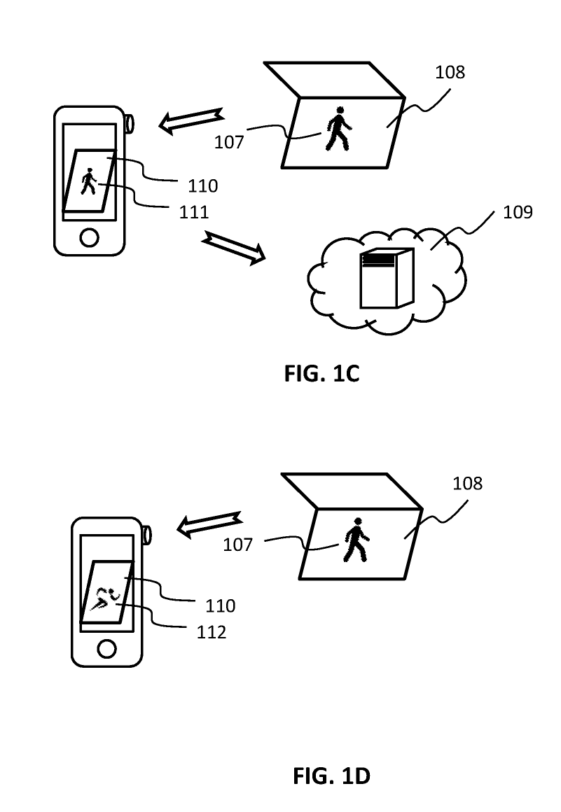

FIG. 1A illustrates capturing a video of a moving object (104) by a system, shown as a smartphone (101) having a camera (103). While of after capturing the video, the video is displayed on a screen (102), facilitating extraction of an image from the video. Even though a screen is shown in FIG. 1A, the system can use other display devices, such as those that project an image or video to an external screen or into a user's eye (e.g., Google® glass, Microsoft HoloLens).

Extraction of an image from the video can be carried out in a number of different ways. For instance, a screenshot can be taken while the video is playing, or paused. In another example, a frame from the video file is taken as the selected image. Yet alternatively, more than one frames from the video file can be combined to form the selected image. The selected image is illustrated as 105 in FIG. 1B.

In one aspect, the image is not directly selected from the video. Rather, in one aspect, the image can be captured separately by the optical sensor on the object. In another aspect, the image can be an artistic alteration of a selected or captured image as describe above. In some aspects, the image is not a barcode.

In some aspects, user input can be taken during selection of the image. For instance, the user can playback the video file on the system, and instruct the system, through a human user interface, to select a frame being displayed or take a screenshot. In some aspects, the human user interface is a button connected to the system, or a touchscreen.

A video can also be generated from still images. To create a video from multiple images, the system displays the image gallery for the user to choose photos. In general, the user can choose any number of images, and the user can define the time length each image displays and how the transition between each image be. The user should be also able to define the order of these images either by selecting them in a specific order, or dragging them into the preferred position in the selected image group.

A music selection functionality can be provided for the user to choose a background music for the video. Music for different themes or the music of different artists can be added to the final video. The volume of the background music and the sound from the original video footage (if the video footage has sound) can be mixed. Specifically, the mix percentage of the background music and the video footage can be adjusted if necessary.

The video can be composited locally. Some time, the video can be cropped to fit a card design. Video processing and compressing can be carried out locally on a user device to achieve high efficiency and reduce file size.

### Template Selection, 3D Rendering and Preview

The system can be configured to allow a user to choose a layout and optionally a background image for the design (e.g., for a greeting card). In this context, the system can be configured to include a template database. In some embodiments, the system is further configured to recommend one or more templates based on the time, date, season, profile of a user, or content of the image or video, without limitation.

Three-dimensional (3D) content can be added and customized by the user. A 3D rendering module can include three parts, a parser, an animator, and a particle tool. The parser is used to convert saved 3D effects in the memory to draw in real time. When the parser loads the effects and starts to play in the preview/3D rendering module, the user is able to customize the effect such as the loaded characters, the effects categories and color, etc. Such customization information can be saved along with a project (e.g., a purchase order). Therefore, when the receiver views the card with the augmentation module, the 3D customization information can be downloaded and parsed by the parser, so that the receiver can view the effects as the sender designed in the preview/3D rendering module.

The animator is a component which is used to load the 3D models saved in compressed format. It can support both static model or model with multiple animation sequences, for example, a humanoid character model with animation clips including walking, jumping, and running. Therefore, the animator component can switch status of the character dynamically during display.

The particle tool is the component which runs the particle effects. In general, it generates each particle (unit) with its properties and put it into the memory, the computer then directly draws them on the screen.

In an exemplary embodiment, a 3D design includes firework words effects. The firework words effect can show words or binary images with grouped particles in AR, like real fireworks combined to words or patterns in the sky. The system can be configured to render user-defined words into a binary image with only black and white color. The white region in the image can be considered as path. When the system generates the particles, it only generates particles in the path, and, in certain situations or at certain time, does not give them any gravity so they do not fall off quickly from sky (i.e., staying in the air). In some aspects, the user can also define the time when the firework words end, at which moment the system can give all the particles in the path a random speed so the words can explode which makes a nice end of the AR experience.

### Image Sharing

In one embodiment, the program code of the system includes computer-readable instructions to carry out an image sharing function which can be referred to as an image sharing module.

With reference to FIG. 1B, once the image 105 is selected, it can be shared with another user. In some embodiments, the sharing is mediated by a printout of the image (107) on a physical scaffold, such as a paper card (108). Printing can be carried out with a printer (106) that is connected, such as through a network, to the system.

In some aspects, the image printed on the card is a two-dimensional image. Nevertheless, it is within the scope of the current disclosure that the image can also be printed as a three-dimensional image.

### Video Archiving

In one embodiment, the program code of the system includes computer-readable instructions to carry out a video archiving function which can be referred to as an archiving module. Such instructions, when executed, can configure the system to store the video file in a storage medium.

In one aspect, the storage medium is part of the system. In another aspect, the system transmits the video file, entirely or partially, to a remote server (109). Storage on a remote server can facilitate downloading or playing by another user. In one aspect, the remote server is a conventional database server. In another aspect, the remote server is a cloud server having a distributed system.

In some aspects, the selected image is also archived to the storage medium, and optionally linked to the video. The linking can be done, for instance, in a separate document, table, index or database.

### Image Receiving

The image printed on the physical card can be shared, such as by snail mail, with another user, or saved for future viewing by the user that has created it. The system of one embodiment of the present disclosure, also includes program code that enables any user to view the card.

Thus, in accordance with one embodiment of the disclosure, the program code of the system includes computer-readable instructions to carry out an image receiving function which can be referred to as a receiving module.

As illustrated in FIG. 1C, when a user would like to view (or experience) the card that is generated as described above, the user can direct the optical sensor (e.g., camera) at the image on the card (108). Meanwhile, in one aspect, the system displays a visual representation of at least part of the captured visual signal, which is at least part of the image shown on the card.

As shown in FIG. 1C, the screen displays, live, the entire image (111) and a portion of the card (110).

### Image Recognition and Matching with the Video

In accordance with one embodiment of the disclosure, the program code of the system includes computer-readable instructions to carry out an image recognition and video matching function which can be referred to as a recognition module.

While the image is captured by the optical sensor of the system, the system can select an image from the captured signals as input to identify a video from a local or remote server (109) with which the printed image is associated.

“Associated with” a video, as used herein, refers to a still image, such as 105, that is extracted or otherwise generated from video 102, as described above. Alternatively, the image can be generated separately from the video, but is linked to the video as indicated by a document, table, index, or database.

Selection of the captured image for the matching purpose can be done without user input. For instance, a photo can be taken when the camera is able to focus, or when the camera is directed at an object that has minimum movement within a predefined time period. In another aspect, the user can signal the system to capture a photo when the user sees that the card is within appropriate range and focus for the camera.

In some aspects, if the system fails to identify a video file that is associated with the image, then the system will prompt the user to move the card (or the camera), until a match is found. In another aspect, the system is configured to instruct the user to move the camera around until a match is found.

In some aspects, before matching is carried out, the captured image can be prepped, such as with change of perspective, zoom, contrast, or brightness, and removal of frames and other suspected noise.

Matching can be carried out with various methods. In one aspect, the original selected image is not archived, and the newly captured image has to be matched to the video directly. In the event the original selected image is also archived and linked to the video, matching can be done with the archived image. In either event, image matching can be done with methods known in the art.

### Image Augmentation with Video

Once a video file associated with the printed image is identified, the system can retrieve the video file and playback. In accordance with one aspect of the disclosure, therefore, the program code of the system includes computer-readable instructions to carry out an image augmentation function which can be referred to as an augmenting module.

In one aspect, as illustrated in FIG. 1D, while the system is displaying a visual representation of the image printed on the card, the system can playback the matched video, and overlay the video (112) over the visual representation (110). Therefore, while the system points the optical sensor/camera at the printed still image card, what is displayed is a card on which a video is being played. Such an overlaying visual display is also referred to as “augmented reality.” Augmented reality display methods are known the art. See, for instance, U.S. Pat. No. 6,408,257.

In one aspect, while showing the video on the display, the system removes the still image on the card. In another aspect, the system integrates/blends the still image into the video to generate a uniform visual effect. In some aspects, 3D contents or effects can also be generated and displayed to the user, which are defined by the user that generates/customizes such 3D contents or effects.

The system can superimpose (or overlay) virtual contents (e.g., video, particles and 3D contents) on a physical plane in the real world, like over a still image, which can be a printed image, or one displayed on a separate screen. To this end, the computer needs to understand the 3D environment of the optical sensor and the still image. In one embodiment, the 3D sensing problem is simplified to a case of using a pinhole camera to view a plane in the real world. For instance, if the plane contains a printed image and the computer recognizes the image as to match one in its database, then the problem is divided to three components: 1) find the 2D transformation between the printed image and a matched digital image in database; 2) find or receive the intrinsic parameters of the pinhole camera so the projection from 3D world to 2D video can be resolved; and 3) infer the 3D position of the printed image from the perspective of camera. The intrinsic parameter of the pinhole camera can typically be found in the meta data of the camera. Step 3 can be inferred with information from steps 1 and 2. Therefore, once the transformation is found, a 3D coordinate space can be defined and the 3D contents are able to be drawn accordingly in the video frame, providing augmented reality effects.

To resolve the transformation matrix, multiple equations need to be formed. This can be accomplished by correcting the mapping of feature points between the image and the plane. The mapping can be defined either manually or automatically. For the augmentation module, the correspondence can be located automatically. In computer vision, image features such as the contour of the objects in the image and sharp corners in the image can be automatically detected. A region around these feature locations can be extracted and converted into a descriptor (such as SIFT descriptor, LBP descriptor). The matching of these descriptors can be greedily searched between the printed image and the video frame. If a large amount correspondence is found, then the equation to solve the transformation matrix can be established.

### Computer Systems Suitable for the Present Technology

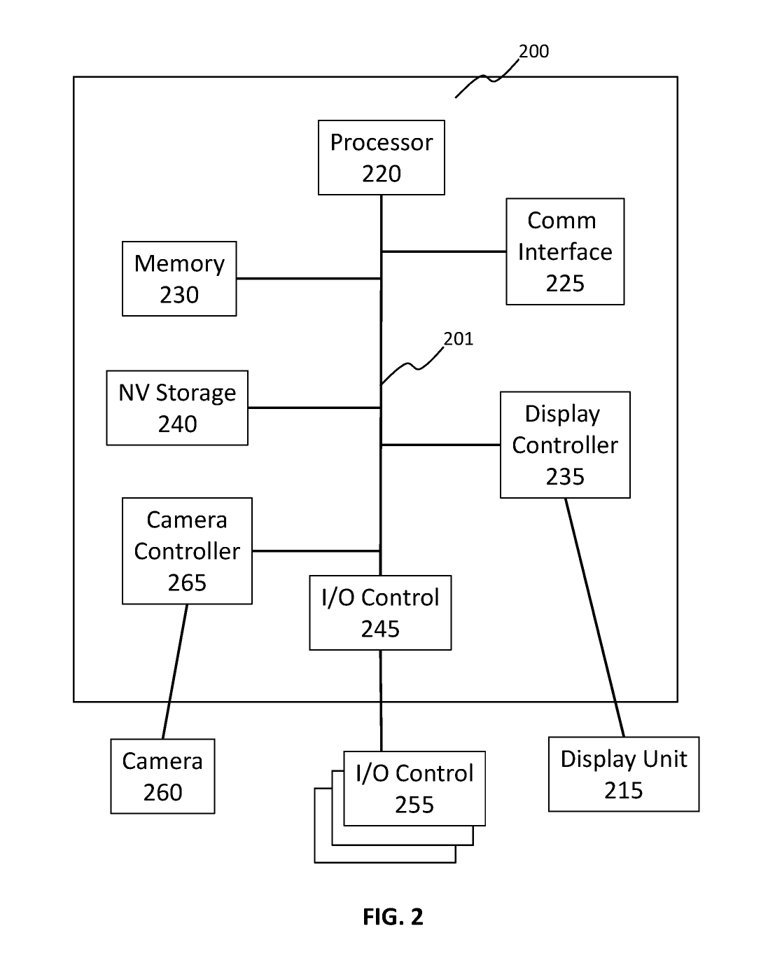

FIG. 2 shows an example of a computer system 200 on which techniques described in this paper can be implemented. The computer system 200 can be a conventional computer system that can be used as a client computer system, such as a wireless client or a workstation, or a server computer system. The computer system 200 includes a computer 205, I/O devices 255, and a display device 215. The computer 205 includes a processor 220, a communications interface 225, memory 230, display controller 235, camera controller 265, non-volatile (NV) storage 240, and I/O controller 245. The computer 205 may be coupled to or include the I/O devices 255, camera 260, and display unit 215.

The computer 205 interfaces to external systems through the communications interface 225, which may include a modem or network interface. It will be appreciated that the communications interface 225 can be considered to be part of the computer system 200 or a part of the computer 205. The communications interface 225 can be an analog modem, ISDN modem, cable modem, token ring interface, satellite transmission interface (e.g., “direct PC”), or other interfaces for coupling a computer system to other computer systems.

The processor 220 may be, for example, a conventional microprocessor such as an Intel Pentium microprocessor or Motorola power PC microprocessor. The memory 230 is coupled to the processor 220 by a bus 250. The memory 230 can be Dynamic Random Access Memory (DRAM) and can also include Static RAM (SRAM). The bus 250 couples the processor 220 to the memory 230, also to the non-volatile storage 240, to the display controller 235, and to the I/O controller 245.

The I/O devices 255 can include a keyboard, disk drives, printers, a scanner, and other input and output devices, including a mouse or other pointing device. The display controller 235 may control in the conventional manner a display on the display device 215, which can be, for example, a cathode ray tube (CRT) or liquid crystal display (LCD). The display controller 235 and the I/O controller 245 can be implemented with conventional well-known technology.

The non-volatile storage 240 is often a magnetic hard disk, an optical disk, or another form of storage for large amounts of data. Some of this data is often written, by a direct memory access process, into memory 230 during execution of software in the computer 205. One of skill in the art will immediately recognize that the terms “machine-readable medium” or “computer-readable medium” includes any type of storage device that is accessible by the processor 220 and also encompasses a carrier wave that encodes a data signal.

The computer system 200 is one example of many possible computer systems that have different architectures. For example, personal computers based on an Intel microprocessor often have multiple buses, one of which can be an I/O bus for the peripherals and one that directly connects the processor 220 and the memory 230 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 230 for execution by the processor 220. A Web TV system, which is known in the art, is also considered to be a computer system, but it may lack some of the features shown in FIG. 2, such as certain input or output devices. A typical computer system will usually include at least a processor, memory, and a bus coupling the memory to the processor.

In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 2.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used in this paper, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g., “direct PC”), or other interfaces for coupling a computer system to other computer systems. Interfaces enable computer systems and other devices to be coupled together in a network.

Several components described in this paper, including clients, servers, and engines, can be compatible with or implemented using a cloud-based computing system. As used in this paper, a cloud-based computing system is a system that provides computing resources, software, and/or information to client devices by maintaining centralized services and resources that the client devices can access over a communication interface, such as a network. The cloud-based computing system can involve a subscription for services or use a utility pricing model. Users can access the protocols of the cloud-based computing system through a web browser or other container application located on their client device.

This paper describes techniques that those of skill in the art can implement in numerous ways. For instance, those of skill in the art can implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As disclosed in this paper, implementations allow editors to create professional productions using themes and based on a wide variety of amateur and professional content gathered from numerous sources. Although the foregoing implementations have been described in some detail for purposes of clarity of understanding, implementations are not necessarily limited to the details provided.

1. A system for information sharing, comprising a processor, memory, an optical sensor, a display unit and program code comprising:
an image selection module that configures the system to receive a first video from a storage medium or capture a first video, display at least part of the first video with the display unit, receive a user input, and extract a first still image from the first video based on the user input;
a sharing module that configures the system to transmit the first still image to a remote device for printing or displaying;
an archiving module that configures the system to transmit the first video to a remote repository;
a receiving module that configures the system to generate a visual representation of at least part of a second still image with the optical sensor;
a recognition module that configures the system to identify a second video from which the second still image is extracted, from the remote repository and taking the visual representation as input; and
an augmenting module that configures the system to:
(i) determine the location of the second still image by (a) identifying a two-dimensional transformation between the second still image and a frame of the second video, and (b) calculating the location of the second video based on the two-dimensional transformation and characteristics of the optic sensor; and
(ii) display the second video with the display unit and overlay the second video on the visual representation at the location.

2. The system of claim 1, wherein the image selection module configures the system to capture the first video.

3. The system of claim 1, wherein the sharing module configures the remote device to print the first still image.

4. The system of claim 1, wherein the archiving module further configures the system to transmit the first still image to the remote repository.

5. The system of claim 4, wherein the archiving module further configures the system to identify the first still image as associated with the first video.

6. The system of claim 1, wherein the second video is identified by matching the second still image to one or more frames of the second video.

7. The system of claim 1, wherein the second video is identified by matching the second still image to a still image identified by the remote repository as associated with the second video.

8. The system of claim 1, wherein when the second video is overlaid on the visual representation, the visual representation is removed from the display on the display unit.

9. The system of claim 1, wherein when the second video is overlaid on the visual representation, the visual representation is blended into the second video.

10. The system of claim 1, further comprising a 3D rendering module that configures the system to allow a user to add a three-dimensional content to be played along with a video.

11. The system of claim 10, wherein the three-dimensional content comprises text.

12. The system of claim 10, wherein the three-dimensional content comprises fireworks.

13. The system of claim 12, wherein the fireworks are configured so that when the fireworks fall after peaking, the speed of the falling is reduced to allow viewing of the fireworks.

14. The system of claim 13, wherein the reduction is achieved by reducing or eliminating gravity.

15. A system for information sharing, comprising a processor, memory, an optical sensor, a display unit and program code comprising:
an image selection module that configures the system to receive a first video from a storage medium or capture a first video, display at least part of the first video with the display unit, receive a user input, and extract a first still image from the first video based on the user input;
a sharing module that configures the system to transmit the first still image to a remote device for printing or displaying;
an archiving module that configures the system to transmit the first video to a remote repository;
a receiving module that configures the system to generate a visual representation of at least part of a second still image with the optical sensor;
a recognition module that configures the system to identify a second video from which the second still image is extracted, from the remote repository and taking the visual representation as input; and
an augmenting module that configures the system to:
(i) determine the location of the second still image by (a) identifying a two-dimensional transformation between the second still image and a frame of the second video, and (b) calculating the location of the second video based on the two-dimensional transformation and characteristics of the optic sensor; and
(ii) display the second video with the display unit and overlay the second video on the visual representation at the location.

16. A non-transitory computer-readable medium that embeds program code comprising:
an image selection module that configures a system that comprises a processor, memory, an optical sensor, and a display unit to receive a first video from a storage medium or capture a first video, display at least part of the first video with the display unit, receive a user input, and extract a first still image from the first video based on the user input;
a sharing module that configures the system to transmit the first still image to a remote device for printing or displaying;
an archiving module that configures the system to transmit the first video to a remote repository;
a receiving module that configures the system to generate a visual representation of at least part of a second still image with the optical sensor;
a recognition module that configures the system to identify a second video from which the second still image is extracted, from the remote repository and taking the visual representation as input; and
an augmenting module that configures the system to:
(i) determine the location of the second still image by (a) identifying a two-dimensional transformation between the second still image and a frame of the second video, and (b) calculating the location of the second video based on the two-dimensional transformation and characteristics of the optic sensor; and
(ii) display the second video with the display unit and overlay the second video on the visual representation at the location.
